(19) United States
(12) Patent Application Publication
(10) Pub. No.: US 2013/0004402 A1
(43) Pub. Date: Jan. 3, 2013

(54) METHODS AND APPARATUSES FOR PURIFYING PHOSPHORUS PENTAFLUORIDE

(75) Inventors: Robert A. Smith, Kinnelon, AZ (US); Daniel J. Brenner, Madison, NJ (US); Matthew H. Luly, Hamburg, NY (US); Haridasan K. Nair, Williamsville, NY (US); Bernard Pointner, Buffalo, NY (US)

(73) Assignee: Honeywell International Inc., Morristown, NJ (US)

(21) Appl. No.: 13/484,536

(22) Filed: May 31, 2012

Related U.S. Application Data
(60) Provisional application No. 61/502,161, filed on Jun. 28, 2011.

(51) Int. Cl. C01B 25/10; C01B 25/30

(52) U.S. Cl. 423/301

(57) ABSTRACT

Embodiments of methods and apparatuses for purifying phosphorus pentafluoride are provided. The method comprises the step of contacting a feed stream comprising phosphorus pentafluoride and impurities with anhydrous hydrogen fluoride. The anhydrous hydrogen fluoride reduces the impurities from the feed stream to form an impurity-depleted phosphorus pentafluoride effluent.

### CROSS-REFERENCE TO RELATED APPLICATIONS

This application is related to and claims all available benefit of U.S. Provisional Patent Application 61/502,161 filed Jun. 28, 2011, the entire contents of which are herein incorporated by reference.

### FIELD OF THE INVENTION

The present invention relates generally to methods and apparatuses for purifying phosphorus pentafluoride, and more particularly to methods and apparatuses for purifying phosphorus pentafluoride by reducing impurities with anhydrous hydrogen fluoride.

### BACKGROUND OF THE INVENTION

Phosphorus pentafluoride (PF_{S}) can be reacted with lithium fluoride (LiF) to commercially produce lithium hexafluorophosphate (LiPF₆), which is an electrolyte useful in lithium ion batteries. Lithium ion batteries have excellent energy-to-weight ratios, no memory effects, and a slow loss of charge when not in use. Due to their high energy density, lithium ion batteries are commonly used for powering consumer electronics and are growing in popularity for defense, automotive, and aerospace applications.

Some methods for producing phosphorus pentafluoride include reacting fluorine with elemental phosphorus. Two examples of conventional methods for producing phosphorus pentafluoride include (1) the low temperature fluorination of red phosphorus powder suspended in a solvent of trichlorofluoromethane (CFCl₃), and (2) the fluorination of red phosphorus powder with an excess of metal fluoride, such as calcium fluoride (CaF₂) in a batch reaction. A more recently developed method includes providing a phosphorus feed stream and a fluorine feed stream to a reactor to form a phosphorus pentafluoride product. The phosphorus feed stream contains white phosphorus and/or yellow phosphorus, and the fluorine feed stream contains elemental fluorine gas.

Commercially available elemental phosphorus generally contains a small amount of arsenic. Arsenic is right below phosphorus on the periodic table and has chemical similarities to phosphorus. When preparing phosphorus pentafluoride by reacting elemental phosphorus with fluorine, any arsenic that is present will react with fluorine to form arsenic pentafluoride (AsF₅). Moreover, if any oxygen (e.g. oxygen or oxygen containing compounds) is present during the formation of phosphorus pentafluoride, the oxygen will react with the phosphorus and fluorine to form phosphorus oxytrifluoride (POF₃). In the production of lithium hexafluorophosphate from phosphorus pentafluoride, arsenic pentafluoride and phosphorus oxytrifluoride are impurities that will react with lithium fluoride to form lithium hexafluoroarsenate (LiAsF₆) and lithium oxyfluorophosphates (LiPOₓF_{y}, e.g., LiPOF₄), respectively. Lithium hexafluoroarsenate and lithium oxyfluorophosphates are undesirable in lithium ion batteries. To minimize the formation of lithium hexafluoroarsenate and lithium oxyfluorophosphates, producers of lithium hexafluorophosphate typically have strict requirements for the purity of phosphorus pentafluoride limiting the amounts of any arsenic pentafluoride and phosphorus oxytrifluoride. Unfortunately, purifying phosphorus pentafluoride by the removal of these impurities can be difficult and costly. For example, arsenic pentafluoride and phosphorus pentafluoride form a close-boiling mixture that is very difficult to separate by distillation.

Accordingly, it is desirable to provide methods and apparatuses for purifying phosphorus pentafluoride by removing at least a portion of arsenic pentafluoride from a phosphorus pentafluoride product. Moreover, it is desirable to provide methods and apparatuses for purifying phosphorus pentafluoride by removing at least a portion of phosphorus oxytrifluoride from a phosphorus pentafluoride product. Furthermore, other desirable features and characteristics of the present invention will become apparent from the subsequent detailed description of the invention and the appended claims, taken in conjunction with the accompanying drawings and this background of the invention.

### SUMMARY OF THE INVENTION

Methods for purifying phosphorus pentafluoride that may be used, for example, to form lithium hexafluorophosphate are provided herein. In accordance with an exemplary embodiment, a method for purifying phosphorus pentafluoride comprises the step of contacting a feed stream comprising phosphorus pentafluoride and impurities with anhydrous hydrogen fluoride to reduce the impurities and form an impurity-depleted phosphorus pentafluoride effluent.

In accordance with another exemplary embodiment, a method for purifying phosphorus pentafluoride is provided. The method comprises the steps of introducing a feed stream comprising phosphorus pentafluoride and impurities to a scrubber. The scrubber contains anhydrous hydrogen fluoride and is operating at scrubbing conditions such that phosphorus pentafluoride is in a gaseous phase and the anhydrous hydrogen fluoride is in a liquid phase to reduce the impurities from the feed stream and form an impurity-depleted phosphorus pentafluoride effluent. The impurities are selected from the group consisting of arsenic pentafluoride, phosphorus oxytrifluoride, or a combination thereof. The impurity-depleted phosphorus pentafluoride effluent is removed from the scrubber.

In accordance with another exemplary embodiment, a method of forming lithium hexafluorophosphate is provided. The method comprises the steps of contacting a feed stream comprising phosphorus pentafluoride and impurities with anhydrous hydrogen fluoride to reduce the impurities and form an impurity-depleted phosphorus pentafluoride effluent. At least a portion of the impurity-depleted phosphorus pentafluoride effluent is contacted with lithium fluoride to form lithium hexafluorophosphate.

### BRIEF DESCRIPTION OF THE DRAWINGS

Embodiments of the present invention will hereinafter be described in conjunction with the following drawing figures, wherein like numerals denote like elements, and wherein:

FIG. 1 schematically illustrates an apparatus for purifying phosphorus pentafluoride in accordance with an exemplary embodiment;

FIG. 2 schematically illustrates an apparatus for purifying phosphorus pentafluoride in accordance with another exemplary embodiment; and

FIG. 3 graphically represents the vapor pressure of anhydrous hydrogen fluoride as a function of temperature.

### DETAILED DESCRIPTION

The following Detailed Description is merely exemplary in nature and is not intended to limit the invention or the application and uses of the invention. Furthermore, there is no intention to be bound by any theory presented in the preceding Background of the Invention or the following Detailed Description.

The various embodiments contemplated herein relate to methods and apparatuses for purifying phosphorus pentafluoride that may be used, for example, to form lithium hexafluorophosphate. Unlike the prior art, the exemplary embodiments taught herein contact anhydrous hydrogen fluoride (HF) with a feed stream comprising phosphorus pentafluoride (PF₅) and impurities. The impurities include arsenic pentafluoride (AsF₅), phosphorus oxytrifluoride (POF₃), or a combination thereof. The impurities are reduced from the feed stream by the anhydrous hydrogen fluoride to form an impurity-depleted phosphorus pentafluoride effluent and an impurity-containing hydrogen fluoride effluent. In particular, arsenic pentafluoride in the feed stream reacts with the anhydrous hydrogen fluoride to form hexafluoroarsenic acid (HAsF₆) and/or other arsenic-fluoride compounds, such as As₂F₁₁⁻¹, that are less volatile materials and remain with the anhydrous hydrogen fluoride, which is preferably in the liquid phase. Phosphorus oxytrifluoride in the feed stream reacts with the excess of anhydrous hydrogen fluoride to form phosphorus pentafluoride and water. The phosphorus pentafluoride becomes part of the impurity-depleted phosphorus pentafluoride effluent. The hexafluoroarsenic acid and/or other arsenic heavies, such as AsF₅ and As₂F₁₁⁻¹, water, or a combination thereof is dissolved in the anhydrous hydrogen fluoride to form the impurity-containing hydrogen fluoride effluent. In one embodiment, the feed stream is in the gaseous phase and contacts the anhydrous hydrogen fluoride in a scrubber that is operating at conditions such that the operating pressure of the scrubber is greater than the vapor pressure of the anhydrous hydrogen fluoride. These conditions facilitate maintaining the anhydrous hydrogen fluoride in a liquid phase as the impurities are reduced and the gaseous impurity-depleted phosphorus pentafluoride effluent is separated from the impurity-containing hydrogen fluoride.

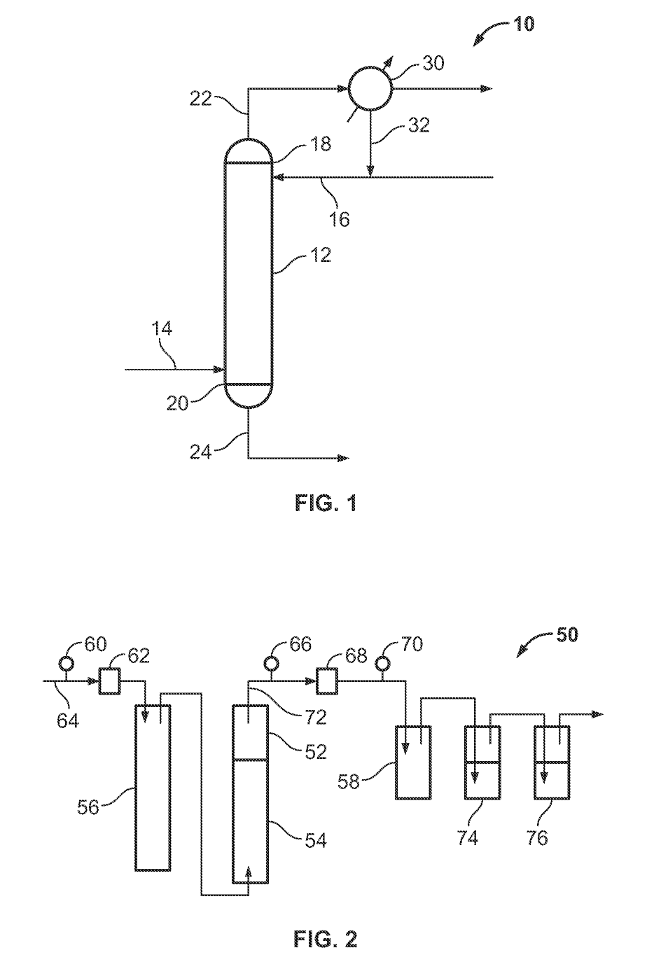

Referring to FIG. 1, a schematic depiction of an apparatus 10 for purifying phosphorus pentafluoride in accordance with an exemplary embodiment is provided. As illustrated, the apparatus 10 is configured for purifying phosphorus pentafluoride in a continuous process. However, it is to be understood that the apparatus 10 can be so configured to purify phosphorus pentafluoride in a batch process or a semi-batch process. The apparatus 10 comprises a scrubber 12. The scrubber 12 may be, for example, a sparged tank, or a countercurrent column that includes packing, trays, and the like, or any other gas-liquid contacting apparatus as is well known in the art. A feed stream 14 comprising phosphorus pentafluoride and impurities is introduced to the scrubber 12. Phosphorus pentafluoride has a relatively low boiling point of about −84.6° C. at atmospheric pressure (about 14.7 psia or about 101 kPa), and preferably the feed stream 14 is introduced to the scrubber 12 at a temperature greater than the boiling point of phosphorus pentafluoride so that the feed stream 14 is in the gaseous phase.

The impurities include arsenic pentafluoride, phosphorus oxytrifluoride, or a combination thereof. In one embodiment, the feed stream 14 comprises arsenic pentafluoride that is present in an amount of about 0.001 to about 1 weight percent (wt. %) of the feed stream 14. In another embodiment, the feed stream 14 comprises phosphorus oxytrifluoride that is present in an amount of about 0.001 to about 1 wt. % of the feed stream 14.

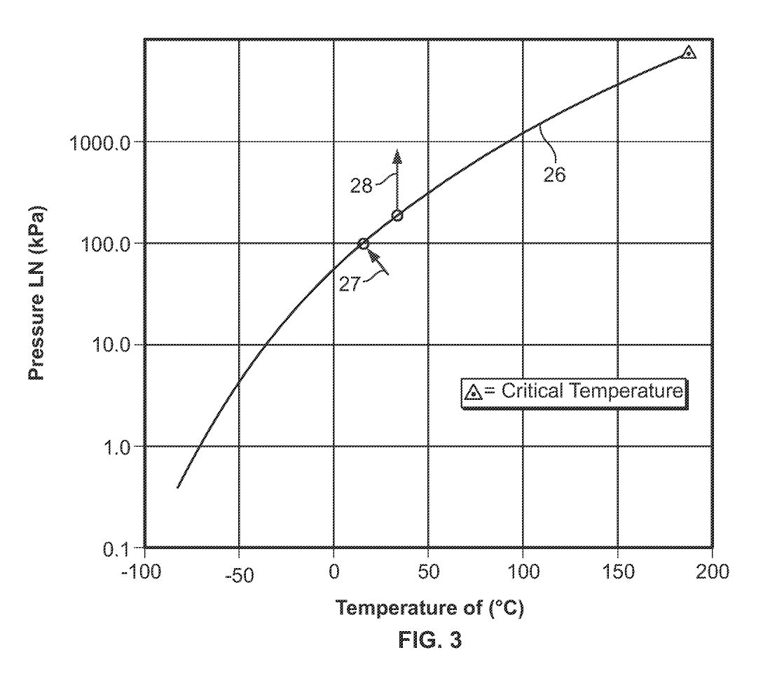

An anhydrous hydrogen fluoride stream 16 is introduced to the scrubber 12. FIG. 3 is a graph illustrating the vapor pressure of anhydrous hydrogen fluoride (curve 26) as a function of temperature. The “x” axis represents temperature (° C.) and the “y” axis represents pressure (kPa). Anhydrous hydrogen fluoride has a normal boiling point of about 19.5° C. (indicated on curve 26 via arrow 27) at atmospheric pressure (about 14.7 psia or about 101 kPa). Preferably, the anhydrous hydrogen fluoride stream 16 is introduced to the scrubber 12 at a temperature below its boiling point so that the anhydrous hydrogen fluoride stream 16 is in the liquid phase. In one embodiment, the feed stream 14 and anhydrous hydrogen fluoride stream 16 are introduced to the scrubber 12 at flow rates such that the feed stream 14 and the anhydrous hydrogen fluoride stream 16 are in contact with each other in the scrubber 12 for a residence time of about 2 seconds or greater, preferably of about 5 seconds or greater, more preferably of about 10 seconds or greater, and most preferably of from about 10 to about 60 seconds.

In an exemplary embodiment, the scrubber 12 is operating at a predetermined temperature and a predetermined pressure such that the predetermined pressure is greater than the vapor pressure of anhydrous hydrogen fluoride (see FIG. 3 curve 26) at the particular predetermined temperature. Preferably, the predetermined pressure is from about 31.3 to about 6466 kPa primarily for economical reasons to limit the expense and operating cost of the apparatus 10. Accordingly, the predetermined temperature for economical reasons is preferably from about −10 to about 188° C. (188° C. is the critical temperature of anhydrous hydrogen fluoride) as defined above the curve 26 representing the vapor pressure of anhydrous hydrogen fluoride. For example, if the predetermined temperature is about 38° C., then the predetermined pressure is about 27.2 psia or greater (187.8 kPa or greater) as indicated via arrow 28. However, higher pressures may be used, or alternatively, lower pressures may be used, such as those defined above the curve 26 from a temperature of from about −10 to about −80° C.

The anhydrous hydrogen fluoride stream 16 and the feed stream 14 as illustrated are introduced to an upper portion 18 and a lower portion 20 of the scrubber 12, respectively. As such, the feed stream 14 rises up through the scrubber 12 in the gaseous phase and the anhydrous hydrogen fluoride stream 16 flows downward through the scrubber 12 in the liquid phase countercurrent to the feed stream 14.

In the scrubber 12, the feed stream 14 contacts the anhydrous hydrogen fluoride stream 16, which reduces the impurities from the feed stream 14 to form an impurity-depleted phosphorus pentafluoride effluent 22 and an impurity-containing hydrogen fluoride effluent 24. In particular, arsenic pentafluoride in the feed stream 14 reacts with the anhydrous hydrogen fluoride to form less volatile arsenic compounds, such as hexafluoroarsenic acid and/or As₂F₁₁⁻¹. Phosphorus oxytrifluoride in the feed stream 14 reacts with the anhydrous hydrogen fluoride to form phosphorus pentafluoride and water. The phosphorus pentafluoride forms part of the impurity-depleted phosphorus pentafluoride effluent 22. The hexafluoroarsenic acid and/or other arsenic heavies, such as AsF₅ and As₂F₁₁⁻¹, water, or a combination thereof is dissolved in the anhydrous hydrogen fluoride to form the impurity-containing hydrogen fluoride effluent 24. In an exemplary embodiment, the impurity-depleted phosphorus pentafluoride effluent 22 is substantially purified to contain arsenic pentafluoride in an amount of about 0.001 wt. % or less, and more preferably of about 0.0005 wt. % or less. Preferably, the arsenic level in the impurity-depleted phosphorus pentafluoride effluent 22 has been reduced by at least about 10 ppmw, and more preferably by at least about 100 ppmw. In another embodiment, the impurity-depleted phosphorus pentafluoride effluent 22 contains phosphorus oxytrifluoride in an amount of about 0.05 wt. % or less.

As illustrated, the impurity-depleted phosphorus pentafluoride effluent 22 is removed from the scrubber 12 and passed through a condenser 30. The condenser 30 liquefies any residual hydrogen fluoride in the impurity-depleted phosphorus pentafluoride effluent 22 and directs the liquefied hydrogen fluoride to the anhydrous hydrogen fluoride stream 16 along line 32. As illustrated, the impurity-containing hydrogen fluoride effluent 24 is removed from the scrubber 12 and may be used in applications where the arsenic content is not critical, or alternatively, the hydrogen fluoride may be separated from the hexafluoroarsenic acid and any other impurities.

The following are examples of the purification of gaseous mixtures containing phosphorus pentafluoride and arsenic pentafluoride using anhydrous hydrogen fluoride. The examples are provided for illustration purposes only and are not meant to limit the various embodiments contemplated herein in any way.

Referring to FIG. 2, a schematic depiction of an apparatus 50 used for the following two examples in accordance with exemplary embodiments is provided. The apparatus 50 comprises a stripping column 52 containing liquid anhydrous hydrogen fluoride 54. The stripping column 52 is downstream from a first vessel 56 and upstream from a second vessel 58. The first and second vessels 56 and 58 provide space to limit the liquid anhydrous hydrogen fluoride 54 contained in the stripping column 52 from being aspirated upstream or downstream, for example, due to sudden pressure changes along the apparatus 50.

A first regulator 60 and a mass flow controller 62 are upstream from the first vessel 56 and cooperatively control the introduction and flow rate of a gaseous mixture 64 to the first vessel 56. The gaseous mixture 64 comprises phosphorus pentafluoride and arsenic pentafluoride. From the first vessel 56, the gaseous mixture 64 is advanced to the stripping column 52 and is bubbled through the anhydrous hydrogen fluoride 54 to reduce arsenic pentafluoride and form an impurity-depleted phosphorus pentafluoride effluent 72.

The impurity-depleted phosphorus pentafluoride effluent 72 is removed from the stripping column 52. A first pressure gauge 66, a back pressure regulator 68, and a second pressure gauge 70 are used to cooperatively control the flow rate of the impurity-depleted phosphorus pentafluoride effluent 72 to the second vessel 58. A first water trap 74 and a second water trap 76 containing predetermined amounts of water are in fluid communication with the second vessel 58 to capture any residual arsenic pentafluoride that may be contained in the impurity-depleted phosphorus pentafluoride effluent 72.

### EXAMPLE 1

### Purification of Phosphorus Pentafluoride by Scrubbing through Anhydrous Hydrogen Fluoride at Atmospheric Pressure

A gaseous mixture 64 comprising about 150 g of phosphorus pentafluoride and about 3244 ppm of arsenic in the form of arsenic pentafluoride was bubbled through 30 g of anhydrous hydrogen fluoride 54 contained in a stripping column 52. The anhydrous hydrogen fluoride 54 was at a temperature of about 1° C. and the stripping column 52 was at atmospheric pressure (about 101 kPa). The gaseous mixture 64 was introduced to the anhydrous hydrogen fluoride 54 at a flow rate of about 10 standard cubic centimeters per minute (sccm). An impurity-depleted phosphorus pentafluoride effluent 72 was formed and removed from the stripping column 52. The impurity-depleted phosphorus pentafluoride effluent 72 was passed through a second vessel 58, a first water trap 74, and a second water trap 76. Water samples were collected over a period of time from the two water traps 74 and 76 and were analyzed for arsenic using inductive coupled plasma spectroscopy (ICP). The results indicated that the arsenic concentration in the impurity-depleted phosphorus pentafluoride effluent 72 was below about 0.3 ppm, indicating that the gaseous mixture 64 had been substantially stripped of arsenic pentafluoride and purified by the anhydrous hydrogen fluoride 54.

### EXAMPLE 2

### Purification of Phosphorus Pentafluoride by Scrubbing through Anhydrous Hydrogen Fluoride at Elevated Pressure

A gaseous mixture 64 comprising about 234.9 g of phosphorus pentafluoride and about 185 ppm of arsenic in the form of arsenic pentafluoride was bubbled through 70 g of anhydrous hydrogen fluoride 54 contained in a stripping column 52. The anhydrous hydrogen fluoride 54 was at a temperature of about 22 to about 28° C. and the stripping column 52 was at a pressure of about 115 psia (about 792 kPa). The gaseous mixture 64 was introduced to the anhydrous hydrogen fluoride 54 at a flow rate of from about 30 to about 40 sccm. An impurity-depleted phosphorus pentafluoride effluent 72 was formed and removed from the stripping column 52. The impurity-depleted phosphorus pentafluoride effluent 72 was passed through a second vessel 58, a first water trap 74, and a second water trap 76. Water samples were collected over a period of time from the first and second water traps 74 and 76 and were analyzed for arsenic using ICP. At the end of the experiment, the anhydrous hydrogen fluoride 54 in the stripping column 52 was analyzed for arsenic using ICP. The results indicated that the arsenic concentrations in the impurity-depleted phosphorus pentafluoride effluent 72 and anhydrous hydrogen fluoride 54 were below about 10 ppm and above 37,000 ppm, respectively, indicating that the gaseous mixture 64 had been substantially stripped of arsenic pentafluoride and purified by the anhydrous hydrogen fluoride 54.

Accordingly, methods and apparatuses for purifying phosphorus pentafluoride have been described. Unlike the prior art, the exemplary embodiments taught herein contact anhydrous hydrogen fluoride with a feed stream comprising phosphorus pentafluoride and impurities. The impurities include arsenic pentafluoride, phosphorus oxytrifluoride, or a combination thereof. The impurities are reduced from the feed stream by the anhydrous hydrogen fluoride to form an impurity-depleted phosphorus pentafluoride effluent and an impurity-containing hydrogen fluoride effluent. In particular, arsenic pentafluoride in the feed stream reacts with the anhydrous hydrogen fluoride to form hexafluoroarsenic acid and other arsenic compounds of relatively low volatility. Phosphorus oxytrifluoride in the feed stream reacts with the anhydrous hydrogen fluoride to form phosphorus pentafluoride and water. The phosphorus pentafluoride becomes part of the impurity-depleted phosphorus pentafluoride effluent. The hexafluoroarsenic acid and/or other arsenic compounds, such as AsF₅ and As₂F₁₁⁻¹, water, or a combination thereof is dissolved in the anhydrous hydrogen fluoride to form the impurity-containing hydrogen fluoride effluent.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended Claims and their legal equivalents.

What is claimed is:

1. A method for purifying phosphorus pentafluoride, the method comprising the step of:
contacting a feed stream comprising phosphorus pentafluoride and impurities with anhydrous hydrogen fluoride to reduce the impurities and form an impurity-depleted phosphorus pentafluoride effluent.

2. The method according to claim 1, wherein the impurities are selected from the group consisting of arsenic pentafluoride, phosphorus oxytrifluoride, or a combination thereof.

3. The method according to claim 2, wherein the step of contacting includes reacting arsenic pentafluoride with the anhydrous hydrogen fluoride to form hexafluoroarsenic acid, AsF₅, As₂F₁₁⁻¹ or combinations thereof.

4. The method according to claim 2, wherein the arsenic pentafluoride is present in an amount of about 0.001 to about 1 wt. % of the feed stream.

5. The method according to claim 2, wherein the step of contacting includes forming the impurity-depleted phosphorus pentafluoride effluent having about 0.001 wt. % or less of the arsenic pentafluoride.

6. The method according to claim 2, wherein the step of contacting includes reacting phosphorus oxytrifluoride with the anhydrous hydrogen fluoride to form phosphorus pentafluoride and water.

7. The method according to claim 2, wherein the phosphorus oxytrifluoride is present in an amount of about 0.001 to about 1 wt. % of the feed stream.

8. The method according to claim 2, wherein the step of contacting includes forming the impurity-depleted phosphorus pentafluoride effluent having about 0.05 wt. % or less of the phosphorus oxytrifluoride.

9. The method according to claim 1, wherein the step of contacting includes contacting the feed stream with the anhydrous hydrogen fluoride at a predetermined temperature and a predetermined pressure, wherein the predetermined pressure is greater than a vapor pressure of the anhydrous hydrogen fluoride at the predetermined temperature.

10. A method for purifying phosphorus pentafluoride, the method comprising the steps of:
introducing a feed stream comprising phosphorus pentafluoride and impurities to a scrubber that contains anhydrous hydrogen fluoride and that is operating at scrubbing conditions such that phosphorus pentafluoride is in a gaseous phase and the anhydrous hydrogen fluoride is in a liquid phase to reduce the impurities and form an impurity-depleted phosphorus pentafluoride effluent, wherein the impurities are selected from the group consisting of arsenic pentafluoride, phosphorus oxytrifluoride, or a combination thereof; and
removing the impurity-depleted phosphorus pentafluoride effluent from the scrubber.

11. The method according to claim 10, wherein the step of introducing includes contacting the feed stream with the anhydrous hydrogen fluoride in the scrubber for a residence time of about 2 seconds or greater.

12. The method according to claim 10, further comprising the steps of:
introducing the anhydrous hydrogen fluoride to the scrubber; and
contacting the feed stream with the anhydrous hydrogen fluoride to reduce the impurities from the feed stream and form an impurity-containing hydrogen fluoride effluent.

13. The method according to claim 12, wherein the step of contacting includes contacting the feed stream with the anhydrous hydrogen fluoride that is flowing countercurrent to the feed stream to form the impurity-depleted phosphorus pentafluoride effluent and the impurity-containing hydrogen fluoride effluent.

14. The method according to claim 12, wherein the step of contacting includes reacting arsenic pentafluoride with the anhydrous hydrogen fluoride to form the impurity-containing hydrogen fluoride effluent comprising hexafluoroarsenic acid, AsF₅, As₂F₁₁⁻¹ or combinations thereof.

15. The method according to claim 12, wherein the step of contacting includes reacting phosphorus oxytrifluoride with the anhydrous hydrogen fluoride to form phosphorus pentafluoride that forms part of the impurity-depleted phosphorus pentafluoride effluent and water that forms part of the impurity-containing hydrogen fluoride effluent.

16. The method according to claim 10, wherein the step of introducing includes operating the scrubber at the scrubbing conditions comprising a predetermined temperature and a predetermined pressure, wherein the predetermined pressure is greater than a vapor pressure of the anhydrous hydrogen fluoride at the predetermined temperature.

17. The method according to claim 16, wherein the step of introducing includes operating the scrubber at the predetermined pressure of from about 31.3 to about 6466 kPa.

18. The method according to claim 17, wherein the step of introducing includes operating the scrubber at the predetermined temperature of from about −10 to about 188° C.

19. The method according to claim 16, wherein the predetermined temperature is of from about −80 to about −10° C.

20. A method of forming lithium hexafluorophosphate, the method comprising the steps of:
contacting a feed stream comprising phosphorus pentafluoride and impurities with anhydrous hydrogen fluoride to reduce the impurities and form an impurity-depleted phosphorus pentafluoride effluent; and
contacting at least a portion of the impurity-depleted phosphorus pentafluoride effluent with lithium fluoride to form lithium hexafluorophosphate.
